(19) United States
(12) Patent Application Publication
(10) Pub. No.: US 2015/0124932 A1
(43) Pub. Date: May 7, 2015

(54) POWER SYSTEM OF X-RAY TUBE AND METHOD OF CONTROLLING THE SAME

(71) Applicant: Delta Electronics, Inc., Taoyuan County (TW)

(72) Inventors: Ming-Whang WANG, Taoyuan County (TW); Hong-Wen CHEN, Taoyuan County (TW); Chung-Heng LEE, Taoyuan County (TW)

(73) Assignee: Delta Electronics, Inc., Taoyuan County (TW)

(21) Appl. No.: 14/175,124

(22) Filed: Feb. 7, 2014

(30) Foreign Application Priority Data
Nov. 4, 2013 (TW) 102139898

(51) Int. Cl. H05G 1/32; H05G 1/10

(52) U.S. Cl. CPC H05G 1/32; H05G 1/10
USPC 378/111

(57) ABSTRACT

A method of controlling a power system of an X-ray tube is provided to supply power to the X-ray tube and control the emission operation of the X-ray tube. The method includes following steps: First, it is to judge whether a high voltage operation of the X-ray tube is started up. Afterward, a high voltage reference signal is gradually increased when the high voltage operation of the X-ray tube is started up. Afterward, it is to judge whether the high voltage reference signal is increased to an upper limit voltage level. Finally, the emission operation of the X-ray tube is executed when the high voltage reference signal is increased to the upper limit voltage level.

### BACKGROUND

1. Technical Field

The present disclosure relates generally to a power system and a method of controlling the same, and more particularly to a power system of an X-ray tube and a method of controlling the same.

2. Description of Related Art

The power circuits of the X-ray tube is mainly composed of a main power circuit and a filament power circuit. The main power circuit is used to step up the external AC power voltage to produce a high voltage by a high-voltage transformer. The produced high voltage is applied between a cathode and an anode of the tube so that electrons generated from the cathode are struck on the anode to produce X-ray. The filament power circuit is used to step down the external AC power voltage to produce a low voltage by a filament transformer. The produced low voltage is applied between two terminals of the filament so that the filament can provide sufficient electrons by thermionic radiation.

Because the X-ray tube beam is driven by the large voltage, the discharge phenomenon caused by instantaneous high voltage results in unstable electrical responses udder the high voltage operation, security concerns, and lifetime reduction of using the system.

Accordingly, it is desirable to provide a power system of an X-ray tube and a method of controlling the same to stabilize electrical responses under the high voltage operation, ensure safe emission operation of the X-ray tube, and increase lifetime of using the system.

### SUMMARY

An object of the present disclosure is to provide a power system of an X-ray tube to solve the above-mentioned problems. Accordingly, the X-ray tube power system includes an X-ray tube, an X-ray power, and a controller. The X-ray power is configured to supply power to the X-ray tube. The controller has a voltage judgment unit and a grid control unit. The voltage judgment unit is configured to receive a high voltage reference signal and an upper limit voltage level. The grid control unit is connected to the voltage judgment unit. The controller is configured to enable a high voltage enable signal and gradually increase the high voltage reference signal when a high voltage operation of the X-ray tube is started up by the X-ray power. The grid control unit is configured to output a grid enable signal to execute an emission operation of the X-ray tube when the voltage judgment unit is configured to judge that the high voltage reference signal is increased to the upper limit voltage level.

Wherein the voltage judgment unit is further configured to receive a lower limit voltage level; the controller is configured to gradually reduce the high voltage reference signal when the emission operation of the X-ray tube is correctly completed; the controller is configured to disable the high voltage enable signal to discontinue the high voltage operation of the X-ray tube when the voltage judgment unit is configured to judge that the high voltage reference signal is reduced to the lower limit voltage level.

Wherein when the high voltage operation of the X-ray tube is started up by the X-ray power, a delay time is provided before the high voltage reference signal is gradually increased.

Wherein when the high voltage reference signal is reduced to the lower limit voltage level, a protection time is provided.

Another object of the present disclosure is to provide a method of controlling a power system of an X-ray tube provided to supply power to an X-ray tube and control an emission operation of the X-ray tube to solve the above-mentioned problems. Accordingly, the method includes following steps: (a) judging whether a high voltage operation of the X-ray tube is started up; (b) gradually increasing a high voltage reference signal when the high voltage operation of the X-ray tube is started up; (c) judging whether the high voltage reference signal is increased to an upper limit voltage level; and (d) executing the emission operation of the X-ray tube when the high voltage reference signal is increased to the upper limit voltage level.

Wherein after the step (d) further comprises: (e) judging whether the emission operation of the X-ray tube is correctly completed; (f) gradually decreasing the high voltage reference signal when the emission operation of the X-ray tube is correctly completed; (g) judging whether the high voltage reference signal is reduced to a lower limit voltage level; and (h) executing the step (a) when the high voltage reference signal is reduced to the lower limit voltage level.

Wherein in the step (b), a high voltage enable signal is enabled to gradually increase the high voltage reference signal when the high voltage operation of the X-ray tube is started up; wherein after the step (c), the high voltage reference signal is continually increased when the high voltage reference signal is not yet reached to the upper limit voltage level; wherein in the step (d), a grid enable signal is enabled to execute the emission operation of the X-ray tube when the high voltage reference signal is increased to reach to the upper limit voltage level.

Wherein in the step (f), the grid enable signal is disabled to gradually reduce the high voltage reference signal when the emission operation of the X-ray tube is correctly completed; wherein after the step (g), the high voltage reference signal is continually decreased when the high voltage reference signal is not yet reduced to the lower limit voltage level; wherein in the step (h), the high voltage enable signal is disabled and then the step (a) is executed when the high voltage reference signal is reduced to the lower limit voltage level.

Wherein before the step (a), further comprising: (a01) powering on the X-ray tube power system and initializing the X-ray tube power system; and (a02) being the X-ray tube power system in a standby status.

Wherein after the step (a), the step (a02) is executed when the high voltage operation of the X-ray tube is not yet started up.

Wherein after the step (e), an error warning message is generated and then the step (a) is executed.

Wherein in the step (b), when the high voltage operation of the X-ray tube is started up, a delay time is provided before the high voltage reference signal is gradually increased.

Wherein in the step (h), when the high voltage reference signal is reduced to the lower limit voltage level, a protection time is provided before the step (a) is executed.

Further another object of the present disclosure is to provide a method of controlling a power system of an X-ray tube provided to supply power to an X-ray tube and control an emission operation of the X-ray tube to solve the above-mentioned problems. Accordingly, the method includes following steps: (a) judging whether a high voltage operation of the X-ray tube is started up; (b) gradually increasing a high voltage reference signal when the high voltage operation of the X-ray tube is started up; (c) judging whether the high voltage reference signal is increased to an upper limit voltage level; (d) executing the emission operation of the X-ray tube when the high voltage reference signal is increased to the upper limit voltage level; (e) judging whether the emission operation of the X-ray tube is correctly completed; (f) gradually decreasing the high voltage reference signal when the emission operation of the X-ray tube is correctly completed; (g) judging whether the high voltage reference signal is reduced to a lower limit voltage level; and (h) executing the step (a) when the high voltage reference signal is reduced to the lower limit voltage level.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic view of an X-ray tube power system according to the present disclosure;

FIG. 2 is a flowchart of a method of controlling the X-ray tube power system according to a first embodiment of the present disclosure;

FIG. 3 is a flowchart of the method of controlling the X-ray tube power system according to a second embodiment of the present disclosure;

FIG. 4 is a timing diagram of the X-ray tube power system according to a first embodiment of the present disclosure;

FIG. 5 is a timing diagram of the X-ray tube power system according to a second embodiment of the present disclosure;

FIG. 6 is a timing diagram of the X-ray tube power system according to a third embodiment of the present disclosure;

FIG. 7 is a timing diagram of the X-ray tube power system according to a fourth embodiment of the present disclosure; and

FIG. 8 is a schematic block diagram of the X-ray tube power system according to the present disclosure.

### DETAILED DESCRIPTION

Reference will now be made to the drawing figures to describe the present invention in detail.

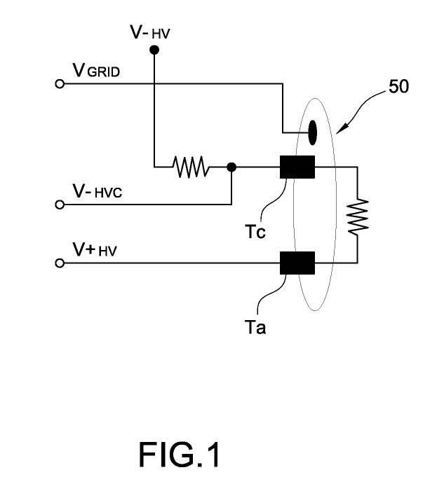

Reference is made to FIG. 1 which is a schematic view of an X-ray tube power system according to the present disclosure. The X-ray tube power system mainly includes a grid transformer, a filament transformer, and a high voltage generation circuit. In particular, the X-ray tube is a transmission X-ray tube. The X-ray tube power system is electrically connected to an X-ray tube 50 and supply power to the X-ray tube 50. The X-ray tube 50 has a cathode Tc and an anode Ta. The cathode Tc is usually a filament for producing electrons and the anode Ta is a tungsten target for providing an area on which that electrons strike. In addition, the space between the cathode Tc and the anode Ta maintains a vacuum in the tube. The grid transformer receives a first AC voltage and generates a positive voltage by a rectifying circuit and a filtering circuit. The filament transformer receives a second AC voltage and generates a negative voltage by another rectifying circuit and another filtering circuit. In addition, the filament transformer has further a secondary-side winding to provide the required voltage for preheating the cathode Tc of the X-ray tube 50. The high-voltage generation circuit generates a negative high voltage V_{-HV} and a positive high voltage V_{+HV} to supply power to the cathode Tc and the anode Ta of the X-ray tube 50, respectively, so as to accelerate the electron beam in the tube. The negative voltage outputted from the X-ray tube power system to suppress electron flow energy generated from the cathode Tc of the X-ray tube. Also, the positive voltage outputted from the X-ray tube power system to provide electron flow energy to the anode Ta of the X-ray tube 50 to produce X-ray.

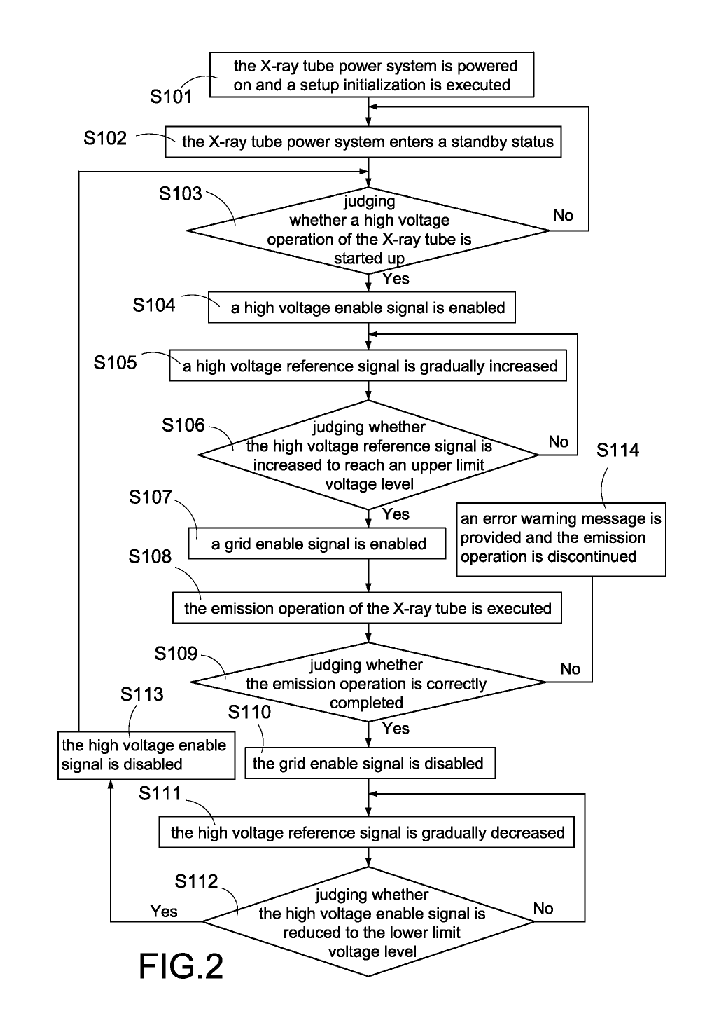

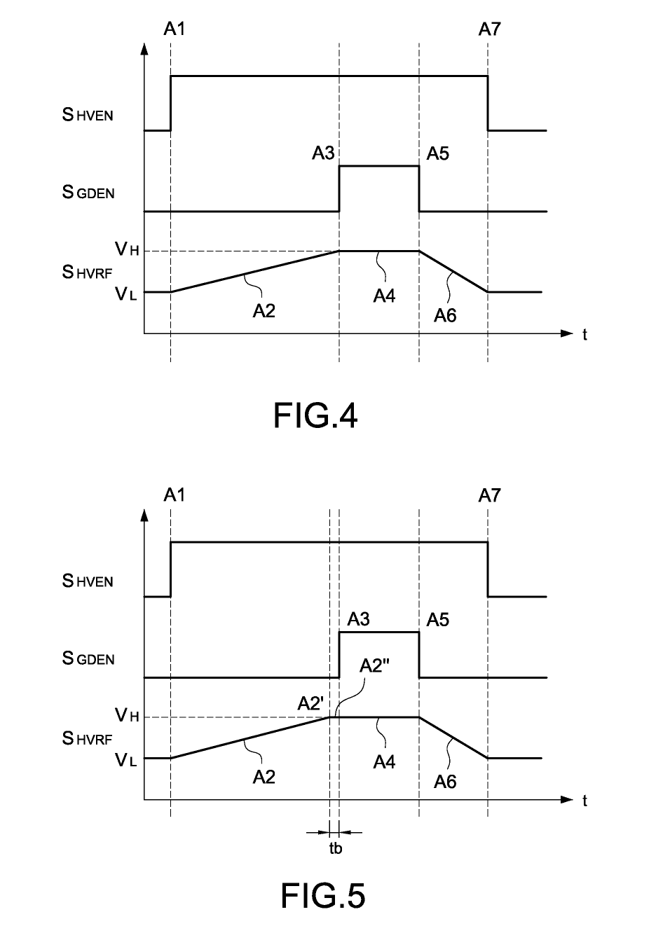

Reference is made to FIG. 2 which is a flowchart of a method of controlling the X-ray tube power system according to a first embodiment of the present disclosure; also reference is made to FIG. 4 which is a timing diagram of the X-ray tube power system according to a first embodiment of the present disclosure. First, the X-ray tube power system is powered on and a setup initialization of the X-ray tube power system is executed (S101). After the setup initialization is completed, the X-ray tube power system enters a standby status (S102). Afterward, the X-ray tube power system judges whether a high voltage operation of the X-ray tube is started up (S103). If the high voltage operation of the X-ray tube is not started up, the X-ray tube power system is still in the standby status. When the high voltage operation of the X-ray tube is started up, a high voltage enable signal S_{HVEN} is enabled (S104). That is, the high voltage enable signal S_{HVEN} is converted from a low level to a high level at a time point A1 as shown in FIG. 4. After the high voltage enable signal S_{HVEN} is enabled, a high voltage reference signal S_{HVRF} is gradually increased (S105). Corresponding to FIG. 4, the high voltage reference signal S_{HVRF} is gradually increased during a time interval A2. More specifically, the high voltage reference signal S_{HVRF} is gradually increased from a lower limit voltage level V_{L} after the high voltage enable signal S_{HVEN} is enabled.

For convenience, the high voltage reference signal S_{HVRF} is gradually increased during the time interval A2 in linear and time-invariant fashions. However, the embodiment is only exemplified but is not intended to limit the scope of the disclosure. In other words, the high voltage reference signal S_{HVRF} can be increased in non-circular slope fashions. Afterward, it is to judge whether the high voltage reference signal S_{HVRF} is increased to reach an upper limit voltage level V_{H} (S106). Especially, because the high voltage reference signal S_{HVRF} is typically set from zero volts to 3.3 volts, the lower limit voltage level V_{L} is equal to zero volts and the upper limit voltage level V_{H} is equal to 3.3 volts. Also, the high voltage reference signal S_{HVRF} from zero volts to 3.3 volts is corresponding to the high voltage of driving the X-ray tube from zero volts to 120 kilo-volts. However, the embodiment is only exemplified but is not intended to limit the scope of the disclosure.

If the high voltage reference signal S_{HVRF} is not yet reached the upper limit voltage level V_{H}, the step (S105) is executed, that is, the high voltage reference signal S_{HVRF} is gradually increased. When the high voltage reference signal S_{HVRF} is increased to reach the upper limit voltage level V_{H}, a grid enable signal S_{GDEN} is enabled (S107). Corresponding to FIG. 4, the grid enable signal S_{GDEN} is converted from a low level to a high level at a time point A3. In other words, the operation of building high voltage of the X-ray tube power system is stable at this time. In general, the time of increasing the high voltage reference signal S_{HVRF} from the lower limit voltage level V_{L} to the upper limit voltage level V_{H} is about three seconds. However, the embodiment is only exemplified but is not intended to limit the scope of the disclosure. When the grid enable signal S_{GDEN} is enabled, the emission operation of the X-ray tube is executed (S108). Corresponding to FIG. 4, the emission operation of the X-ray tube is executed during a time interval A4. Afterward, it is to judge whether the emission operation of the X-ray tube is correctly completed (S109). If the emission operation of the X-ray tube is not yet correctly completed, an error warning message is provided and the emission operation of the X-ray tube is discontinued (S114). In other words, the emission operation of the X-ray tube is unavailable once the high voltage of driving the X-ray tube is decayed under the critical voltage. Accordingly, an error warning message is provided to notify the operator that the emission operation of the X-ray tube is failed and the emission operation of the X-ray tube is discontinued to avoid damaging the operator or the examinees. When the emission operation of the X-ray tube is correctly completed, the grid enable signal S_{GDEN} is disabled (S110). Corresponding to FIG. 4, the grid enable signal S_{GDEN} is converted from a high level to a low level at a time point A5.

When the grid enable signal S_{GDEN} is disabled, the high voltage reference signal S_{HVRF} is gradually decreased (S111). Corresponding to FIG. 4, the high voltage reference signal S_{HVRF} is gradually decreased during a time interval A6. More specifically, the high voltage reference signal S_{HVRF} is gradually increased from 3.3 volts after the high voltage enable signal S_{HVEN} is disabled. In this embodiment, the high voltage reference signal S_{HVRF} is gradually increased during the time interval A6 in linear and time-invariant or RC discharging fashions. However, the embodiments are only exemplified but are not intended to limit the scope of the disclosure. In particular, the decay time of the RC discharging fashion is usually set to two to three seconds.

Afterward, it is to judge whether the high voltage enable signal S_{HVEN} is reduced to the lower limit voltage level V_{L} (S112). If the high voltage reference signal S_{HVRF} is not yet reduced to the lower limit voltage level V_{L}, the step (S111) is executed, that is, the high voltage reference signal S_{HVRF} is gradually decreased. When the high voltage reference signal S_{HVRF} is reduced to the lower limit voltage level V_{L}, the high voltage enable signal S_{HVEN} is disabled (S113). That is, the high voltage enable signal S_{HVEN} is converted from a high level to a low level at a time point A7 as shown in FIG. 4. Accordingly, a complete emission operation of the X-ray tube is completed. Especially, in order to avoid continuously executing two emission operations in a short time, a protection time is provided between two emission operations to ensure safe emission operation of the X-ray tube. More specifically, as shown in FIG. 2, after the step (S113) is finished, the step (S103) is executed, that is, it is to judge whether the high voltage operation of the X-ray tube is started up. Between the two steps, the protection time is provided to ensure safe emission operation of the X-ray tube. In particular, the protection time is set to at least ten seconds. However, the embodiment is only exemplified but is not intended to limit the scope of the disclosure.

Reference is made to FIG. 5 which is a timing diagram of the X-ray tube power system according to a second embodiment of the present disclosure. The major difference between the second embodiment and the first embodiment is that the high voltage reference signal S_{HVRF} is increased to reach the upper limit voltage level V_{H} at a time point A2′, and the grid enable signal S_{GDEN} is enabled after a buffer time tb. In particular, the buffer time tb is provided to ensure the X-ray tube is driven by the high voltage to produce X-ray. Corresponding to FIG. 5, the high voltage reference signal S_{HVRF} is increased to reach the upper limit voltage level V_{H} at the time point A2′. In other words, the operation of building high voltage of the X-ray tube power system is stable at this time. In addition, the high voltage reference signal S_{HVRF} is maintained at the upper limit voltage level V_{H} during a time interval A2″ to ensure safe emission operation of the X-ray tube. Furthermore, the grid enable signal S_{GDEN} is converted from a low level to a high level at a time point A3 so that the emission operation of the X-ray tube is executed during a time interval A4.

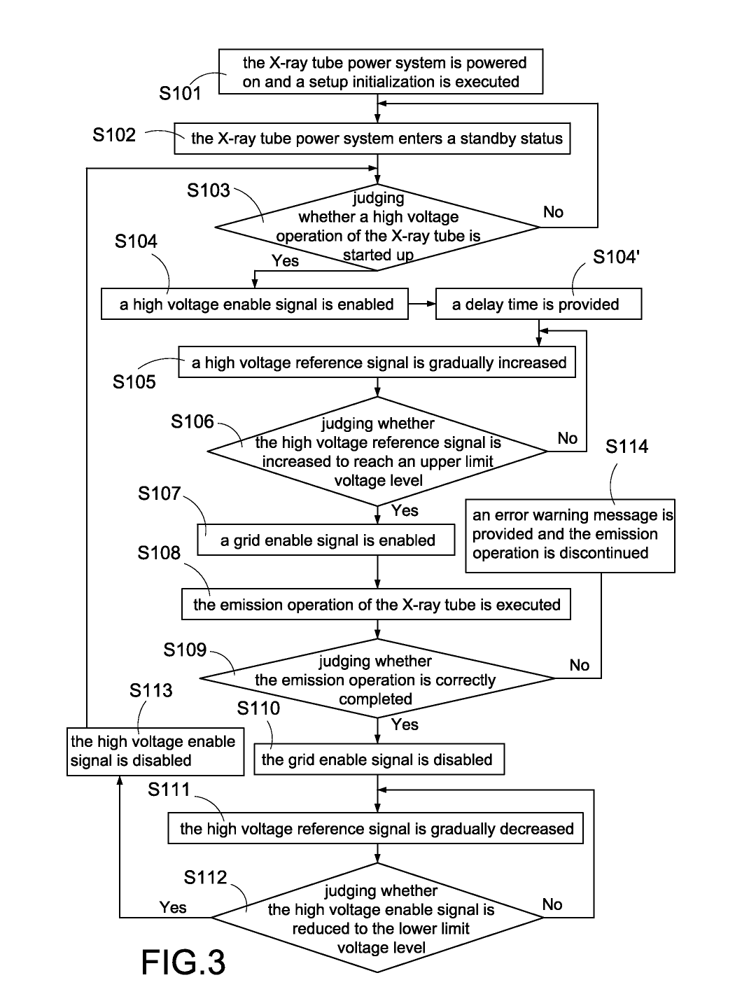

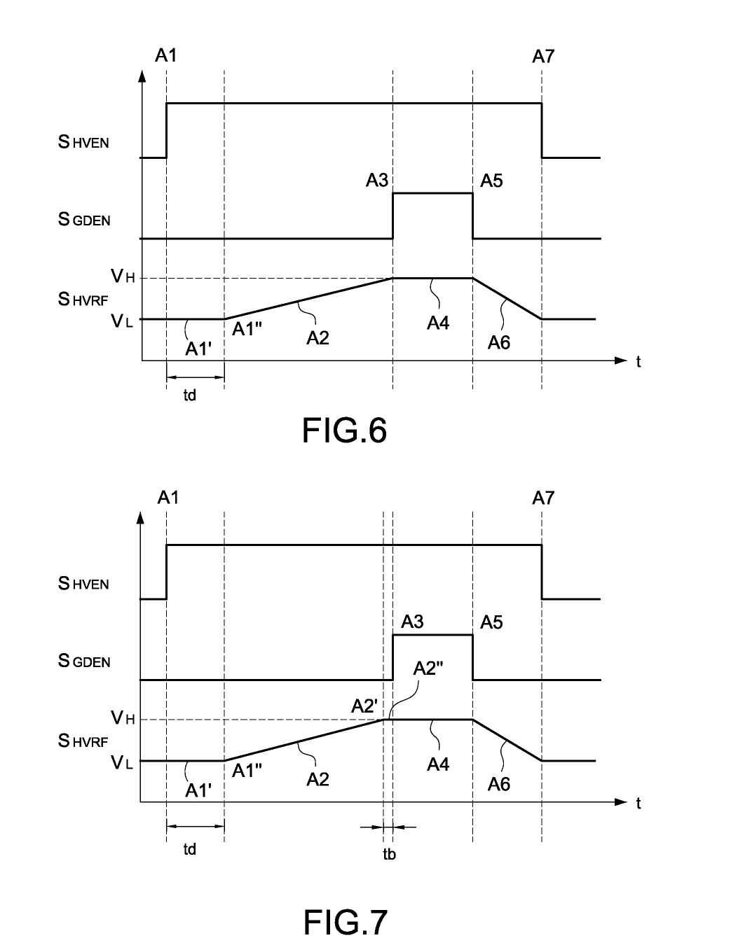

Reference is made to FIG. 6 which is a timing diagram of the X-ray tube power system according to a third embodiment of the present disclosure. The major difference between the third embodiment and the first embodiment is that the high voltage enable signal S_{HVEN} is converted from a low level to a high level at the time point A1, and the high voltage reference signal S_{HVRF} is gradually increased after a delay time td. That is, the high voltage reference signal S_{HVRF} is maintained at the lower limit voltage level V_{L} during a time interval A1′, and then the high voltage reference signal S_{HVRF} is gradually increased until a time point A1″. Reference is made to FIG. 3 which is a flowchart of the method of controlling the X-ray tube power system according to a second embodiment of the present disclosure. The major difference between FIG. 3 and FIG. 2 is that the step (S105) is executed after the high voltage enable signal S_{HVEN} is enabled and the delay time td is provided (S104′). That is, the high voltage reference signal S_{HVRF} is gradually increased after the high voltage enable signal S_{HVEN} is enabled and the delay time td is provided. Accordingly, the X-ray tube power system can provide self-test function according to detection signals during the delay time td, thus increasing the reliability and stability of system operation.

Reference is made to FIG. 7 which is a timing diagram of the X-ray tube power system according to a fourth embodiment of the present disclosure. The major difference between the fourth embodiment and the first embodiment is that the high voltage enable signal S_{HVEN} is converted from a low level to a high level at the time point Al and the high voltage reference signal S_{HVRF} is maintained at the lower limit voltage level V_{L} during the time interval A1′, and then the high voltage reference signal S_{HVRF} is gradually increased until the time point A1″. In particular, the high voltage reference signal S_{HVRF} is increased to reach to the upper limit voltage level V_{H} at a time point A2′. At this time, the operation of building high voltage of the X-ray tube power system is stable. Also, the high voltage reference signal S_{HVRF} is maintained at the upper limit voltage level V_{H} during a time interval A2″. Until a time point A3, the grid enable signal S_{GDEN} is converted from a low level to a high level so that the emission operation of the X-ray tube is executed during a time interval A4. In other words, the fourth embodiment is substantially equal to the combination of the third embodiment and the second embodiment to provide both the delay time td and the buffer time tb.

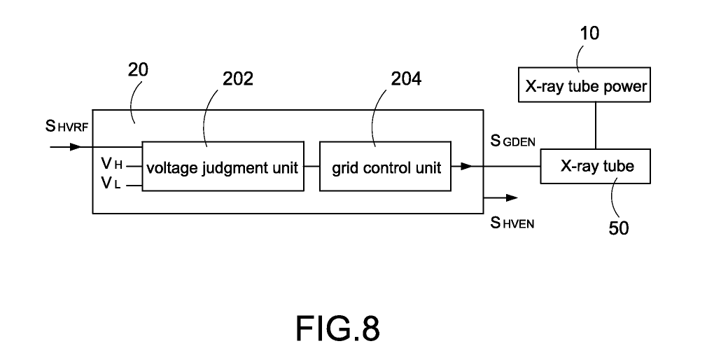

Reference is made to FIG. 8 which is a schematic block diagram of the X-ray tube power system according to the present disclosure. The X-ray tube power system includes an X-ray tube 50, an X-ray tube power 10, and a controller 20. The X-ray tube power 10 is provided to supply power to the X-ray tube 50. In particular, the X-ray tube power 10 is consisted of the above-mentioned grid transformer, the filament transformer, and the high-voltage generation circuit. In other words, the X-ray tube power 10 provides the required power to execute the emission operation of the X-ray tube 50.

The controller 20 includes a voltage judgment unit 202 and a grid control unit 204. The voltage judgment unit 202 receives a high voltage reference signal S_{HVRF} and an upper limit voltage level V_{H}. The grid control unit 204 is connected to the voltage judgment unit 202. First, the X-ray tube power system is powered on and a setup initialization of the X-ray tube power system is executed. After the setup initialization is completed, the X-ray tube power system enters a standby status. When the X-ray tube power 10 starts up the high voltage operation of the X-ray tube 50, the controller 20 enables a high voltage enable signal S_{HVEN} and gradually increases the high voltage reference signal S_{HVRF}. When the voltage judgment unit 202 judges the high voltage reference signal S_{HVRF} reaches to the upper limit voltage level V_{H}, the grid control unit 204 outputs a grid enable signal S_{GDEN} to execute the emission operation of the X-ray tube 50. Especially, when the high voltage operation of the X-ray tube 50 is started up and before the high voltage reference signal is gradually increased, a delay time can be provided so that the X-ray tube power system can provide self-test function according to detection signals during the delay time td, thus increasing the reliability and stability of system operation.

In addition, the voltage judgment unit 202 further receives a lower limit voltage level V_{L}. When the emission operation of the X-ray tube 50 is correctly completed, the high voltage reference signal S_{HVRF} is gradually decreased. When the voltage judgment unit 202 judges the high voltage reference signal S_{HVRF} is reduced to the lower limit voltage level V_{L}, the controller 20 disables the high voltage enable signal S_{HVEN} to discontinue the high voltage operation of the X-ray tube. Especially, when the high voltage reference signal is reduced to the lower limit voltage level V_{L} and before the X-ray tube power system is executed again, a protection time is provided to ensure safe emission operation of the X-ray tube 50.

Because the high voltage reference signal S_{HVRF} is typically set from zero volts to 3.3 volts, the lower limit voltage level V_{L} is equal to zero volts and the upper limit voltage level V_{H} is equal to 3.3 volts. Also, the high voltage reference signal S_{HVRF} from zero volts to 3.3 volts is corresponding to the high voltage of driving the X-ray tube from zero volts to 120 kilo-volts. However, the embodiment is only exemplified but is not intended to limit the scope of the disclosure.

Especially, if the emission operation of the X-ray tube is not yet correctly completed, an error warning message is provided to notify the operator that the emission operation of the X-ray tube is failed and the emission operation of the X-ray tube is discontinued to avoid damaging the operator or the examinees.

In conclusion, the present disclosure has following advantages:

1. Comparing to the prior art emission operation of the X-ray tube, the high voltage reference signal S_{HVRF} is gradually and smoothly increased from the lower limit voltage level V_{L} to the upper limit voltage level V_{H} to avoid the discharge phenomenon caused by instantaneous high voltage, thus stabilizing electrical responses under the high voltage operation, ensuring safe emission operation, and increasing lifetime of using the system;

2. The delay time td is provided to provide self-test function according to detection signals during the delay time td, thus increasing the reliability and stability of system operation;

3. The buffer time tb is provided to ensure the X-ray tube is driven by the high voltage to produce X-ray;

4. The protection time is provided to ensure safe emission operation of the X-ray tube; and

5. If the emission operation of the X-ray tube is not yet correctly completed, an error warning message is provided to notify the operator that the emission operation of the X-ray tube is failed and the emission operation of the X-ray tube is discontinued to avoid damaging the operator or the examinees.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An X-ray tube power system comprising:
an X-ray tube;
an X-ray power configured to supply power to the X-ray tube; and
a controller comprising:
a voltage judgment unit configured to receive a high voltage reference signal and an upper limit voltage level; and
a grid control unit connected to the voltage judgment unit;
wherein the controller is configured to enable a high voltage enable signal and gradually increase the high voltage reference signal when a high voltage operation of the X-ray tube is started up by the X-ray power; the grid control unit is configured to output a grid enable signal to execute an emission operation of the X-ray tube when the voltage judgment unit is configured to judge that the high voltage reference signal is increased to the upper limit voltage level.

2. The X-ray tube power system in claim 1, wherein the voltage judgment unit is further configured to receive a lower limit voltage level; the controller is configured to gradually reduce the high voltage reference signal when the emission operation of the X-ray tube is correctly completed; the controller is configured to disable the high voltage enable signal to discontinue the high voltage operation of the X-ray tube when the voltage judgment unit is configured to judge that the high voltage reference signal is reduced to the lower limit voltage level.

3. The X-ray tube power system in claim 1, wherein when the high voltage operation of the X-ray tube is started up by the X-ray power, a delay time is provided before the high voltage reference signal is gradually increased.

4. The X-ray tube power system in claim 2, wherein when the high voltage reference signal is reduced to the lower limit voltage level, a protection time is provided.

5. A method of controlling a power system of an X-ray tube provided to supply power to an X-ray tube and control an emission operation of the X-ray tube, the method comprising following steps:
(a) judging whether a high voltage operation of the X-ray tube is started up;
(b) gradually increasing a high voltage reference signal when the high voltage operation of the X-ray tube is started up;
(c) judging whether the high voltage reference signal is increased to an upper limit voltage level; and
(d) executing the emission operation of the X-ray tube when the high voltage reference signal is increased to the upper limit voltage level.

6. The method of controlling the power system of the X-ray tube in claim 5, wherein after the step (d) further comprises:
(e) judging whether the emission operation of the X-ray tube is correctly completed;
(f) gradually decreasing the high voltage reference signal when the emission operation of the X-ray tube is correctly completed;
(g) judging whether the high voltage reference signal is reduced to a lower limit voltage level; and
(h) executing the step (a) when the high voltage reference signal is reduced to the lower limit voltage level.

7. The method of controlling the power system of the X-ray tube in claim 5, wherein in the step (b), a high voltage enable signal is enabled to gradually increase the high voltage reference signal when the high voltage operation of the X-ray tube is started up; wherein after the step (c), the high voltage reference signal is continually increased when the high voltage reference signal is not yet reached to the upper limit voltage level; wherein in the step (d), a grid enable signal is enabled to execute the emission operation of the X-ray tube when the high voltage reference signal is increased to reach to the upper limit voltage level.

8. The method of controlling the power system of the X-ray tube in claim 6, wherein in the step (f), the grid enable signal is disabled to gradually reduce the high voltage reference signal when the emission operation of the X-ray tube is correctly completed; wherein after the step (g), the high voltage reference signal is continually decreased when the high voltage reference signal is not yet reduced to the lower limit voltage level; wherein in the step (h), the high voltage enable signal is disabled and then the step (a) is executed when the high voltage reference signal is reduced to the lower limit voltage level.

9. The method of controlling the power system of the X-ray tube in claim 5, wherein before the step (a), further comprising:
(a01) powering on the X-ray tube power system and initializing the X-ray tube power system; and
(a02) being the X-ray tube power system in a standby status.

10. The method of controlling the power system of the X-ray tube in claim 9, wherein after the step (a), the step (a02) is executed when the high voltage operation of the X-ray tube is not yet started up.

11. The method of controlling the power system of the X-ray tube in claim 6, wherein after the step (e), an error warning message is generated and then the step (a) is executed.

12. The method of controlling the power system of the X-ray tube in claim 5, wherein in the step (b), when the high voltage operation of the X-ray tube is started up, a delay time is provided before the high voltage reference signal is gradually increased.

13. The method of controlling the power system of the X-ray tube in claim 8, wherein in the step (h), when the high voltage reference signal is reduced to the lower limit voltage level, a protection time is provided before the step (a) is executed.

14. A method of controlling a power system of an X-ray tube provided to supply power to an X-ray tube and control an emission operation of the X-ray tube, the method comprising following steps:
(a) judging whether a high voltage operation of the X-ray tube is started up;
(b) gradually increasing a high voltage reference signal when the high voltage operation of the X-ray tube is started up;
(c) judging whether the high voltage reference signal is increased to an upper limit voltage level;
(d) executing the emission operation of the X-ray tube when the high voltage reference signal is increased to the upper limit voltage level;
(e) judging whether the emission operation of the X-ray tube is correctly completed;
(f) gradually decreasing the high voltage reference signal when the emission operation of the X-ray tube is correctly completed;
(g) judging whether the high voltage reference signal is reduced to a lower limit voltage level; and
(h) executing the step (a) when the high voltage reference signal is reduced to the lower limit voltage level.
